(19) United States
(12) Patent Application Publication
(10) Pub. No.: US 2008/0095058 A1
(43) Pub. Date: Apr. 24, 2008

(54) Data Transmission in a Communication Network

(75) Inventors: Francesc Dalmases, Bellaterra-Barcelona (ES); Mei-Ling Bow, Blakehurst (AU)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/571,575

(22) PCT Filed: Jul. 4, 2005
(86) PCT No.: PCT/IB05/52213

§ 371 Date: Jan. 3, 2007

(30) Foreign Application Priority Data
Jul. 9, 2004 (EP) 04103281.4

(51) Int. Cl. G08C 15/00

(52) U.S. Cl. 370/237

(57) ABSTRACT

A mobile ad hoc network describes an ad hoc network in which each connection point or network node changes its position dynamically. Such a network is known for rapid changes of the network topology whereas each node is able to join and leave the network dynamically and often without warning. These dynamic changes can lead to the degrading of the stability of links between the network nodes. According to the present invention, a method is provided to smoothly replace degrading links with stable ones. Advantageously, this results in higher network stability and offers a high flexibility for routes in a dynamically changing network.

The present invention relates to the field of communication networks and to routing protocols. In particular, the present invention relates to a method of transmitting data in a communication network, to a corresponding network and elements thereof.

Other than fixed networks the connection between network nodes in wireless networks is not done by fixed lines. Wireless networks use the air to connect two or more peers with each other. The links are radio channels and thus the quality of the links may vary. Additional to bandwidth limitations negative effects like interference, reflections, attenuations caused by the distance between the communication partners have impact to the quality of the links. And the worse the link quality the lower is the usable bandwidth which correspond to the usable rate. So may a stable link may degrade as communication devices diverge.

In the development of next generation wireless networks, there is presently a lot of work being done on so-called “ad hoc” networks, which do not rely on any pre-existing network infrastructure. Instead, these networks are formed in an on demand fashion, as soon as the devices are in range of each other. These types of networks have the advantage of not requiring any stationary network components, such as routers and base stations, as well as cabling and central administration.

A mobile ad hoc network (MANET) is an ad hoc network, in which each connection point or node changes its position dynamically. MANETs are known for rapid changes in the network topology, as each node is able to join and leave the network dynamically and often without warning. Due to this and the limited transmission range of wireless nodes, current ad-hoc networks use what is known as multi-hop routing to enable two nodes to communicate when not in immediate range of each other. This works by having intermediate nodes acting as routers, forwarding the information from node to node until it reaches the destination. The effectiveness of finding the communication path through these networks lies in the routing algorithm and its implementation. One popular routing protocol for MANETs is Ad hoc On Demand Distance Vector (AODV). It relies on dynamically establishing route table entries at intermediate nodes, which means that each node along a particular path maintains a routing table entry for each destination network node down the same path. The most widely fielded Wireless LAN networks use the IEEE 802.11 standard for the medium access control (MAC) layer and the physical (PHY) layer. Its high-speed versions (IEEE 802.11a and IEEE 802.11g) support eight raw data rates up to 54 Mbps. As a result, links can have different delivery rates. Many routing protocols, including AODV, have neglected the effects of multi-rate networks on their performance, making a binary classification of the link connectivity. Independent of their speed and reliability, links are divided between active and broken.

At the same time, most of the routing protocols use minimum number of hops as the criteria for the selection of a route. Consequently, the protocol tends to choose long range links which could reduce the number of hops between nodes. Since the larger the range of the link, the lower its rate, the minimum hop criteria mostly selects slow links. Also low speed links use to be at the edge of reliability being about to break.

As an example, AODV uses broadcast messages such as HELLO and RREQ (route request) messages to find communication paths in the networks. HELLO is a message type, which periodically is sent by a network node to its neighbour network nodes, when the network node has not broadcasted any packet within a defined period of time. An RREQ message is sent by any source network node, which has to send information to a destination network node in the communication network, but has no valid data transmission route to that destination. As every network node, which receives an RREQ message and has no valid data transmission route to the destination, sends the RREQ message to all of its neighbour network nodes, the network is effectively flooded until a valid data transmission route to the destination is found. In IEEE 802.11 systems, broadcast messages are sent at the basic rate, which is 6 Mbps for the 802.11a version, and as a consequence have a higher range than it would have at the operational speed of the device, which usually should exceed the basic rate. This means that the protocol will find routes, which are able to transmit data at 6 Mbps, but not necessarily at a higher rate. And therefore, by reception of HELLO messages without considering its rate and reliability, a stable link could be replaced with a degrading one, with a small number of hops.

In an article of R. Dube et al. “Signal stability-based adaptive routing (SSA) for ad hoc mobile networks”, in IEEE personal communications, 1997, a routing protocol was suggested taking into account the both Quality of Service (QoS) parameters absolute value of signal strength and stability of the link, when selecting a route. It was shown that this is not a very flexible method.

It is an object of the present invention to provide for an improved data transmission.

According to an exemplary embodiment of the present invention, the above object may be solved by a method for transmitting data in a communication network comprising steps of transmitting data via a first data transmission route, determining a quality variation of the first data transmission route and amending the first data transmission route on the basis of the quality variation.

According to a variant of this exemplary embodiment the quality variation of the route may be determined distributedly by all the nodes in the network in a link basis. Each node estimates the quality of the link to its neighbors.

Advantageously, due to the determination of the quality variation on the first data transmission route, for example a degrading of the quality may be determined and an appropriate reaction may be caused.

Advantageously, this may allow for an improved data transmission, since, on the basis of the quality variation of the data transmission used, an appropriate action may be taken.

According to another exemplary embodiment of the present invention as set forth in claim 2, the amending of the first data transmission route may be performed such that a switching is initiated from the first data transmission route to a second more stable data transmission route. Thus, in case for example an inappropriate quality variation has been detected on the first data transmission route, i.e. on the data transmission transmitted via the first data transmission route, the data transmission may be re-routed to the second data transmission route.

According to another exemplary embodiment of the present invention as set forth in claim 3, a degrading condition of the first data transmission route is determined.

Advantageously, this may allow to, for example, switch from a first data transmission route to a second data transmission route when a degrading condition such as, for example, an increased error rate or an increased number of undecodable packets have been received. This switching may be performed by each node based on the link quality.

According to another exemplary embodiment of the present invention as set forth in claim 4, the quality variation of the first data transmission route is determined on the basis of a received signal strength. Thus, for example, when the signal strength degrades, appropriate action may be taken to ensure a reasonable data transmission quality.

According to another exemplary embodiment of the present invention as set forth in claim 5, two different routing tables are used and/or updated wherein the second routing table includes data transmission routes which are selected for the data transmission when a degrading condition is determined on a data transmission route in the primary routing table.

According to another exemplary embodiment of the present invention as set forth in claim 6, a received message is analyzed with respect to whether it was received via a degrading link, i.e. a link which has a degrading condition or not. In case it is determined that the message was received on a link having a degrading condition, the message is discarded.

According to another exemplary embodiment of the present invention as set forth in claim 7, the data transmission route is amended by adjusting a data transmission rate of the first data transmission route which may be done on the basis of local measurements of the link quality and link quality information included in the routing control messages.

Thus, in case an inappropriate link quality variation of the first data transmission route is determined, the data transmission rate with which data is transmitted via the first data transmission route is adjusted. For example, the data transmission rate may be increased or decreased.

For example, according to another exemplary embodiment of the present invention as set forth in claim 8, in case a degrading condition of the first data transmission route is determined, the data transmission rate is reduced. In case, as set forth in claim 9, if an improving condition is determined on the first data transmission route, the data transmission rate is increased.

According to another exemplary embodiment of the present invention as set forth in claim 10, a network node for a data transmission network is provided wherein the network node is adapted to transmit data via a link via a first data transmission route. The network node according to this exemplary embodiment of the present invention is adapted to determine a link quality variation of the first data transmission route. Furthermore, the network node is adapted to amend the first data transmission route on the basis of the link quality variation.

Advantageously, this may provide for a network node, which may automatically amend the data transmission route selected on the basis of a quality variation which may allow for improved data transmission.

Further advantageous exemplary embodiments of the present invention are set forth in claims 10-16.

According to another exemplary embodiment of the present invention as set forth in claim 17, a communication network is provided. The communication network is a wireless communication network comprising at least a first network node and a second network node. The first network node is adapted to transmit data via a first data transmission route, which may include further network nodes to the second network node. The first network node is adapted to determine a quality variation of the data transmission via the first data transmission route. The first network node is adapted to amend the first data transmission route on the basis of the quality variation.

Further advantageous exemplary embodiments of the communication network according to the present invention are set forth in claims 18 and 19.

It may be seen as the gist of an exemplary embodiment of the present invention that physical parameters, which provide information about the quality of a link, are determined. Information about a variation in the quality of a link may thus be used to change a transmission route or do adjust a data transmission rate.

These and other aspects of the present invention will become apparent from and elucidated with reference to the embodiments described hereinafter.

Exemplary embodiment of the present invention will be described in the following with reference to the following drawings.

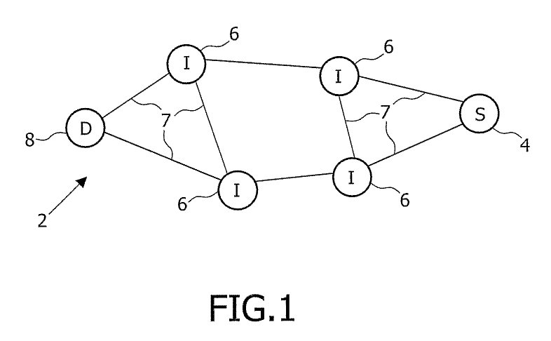

FIG. 1 shows a schematic representation of an exemplary data transmission network comprising network nodes according to the present invention.

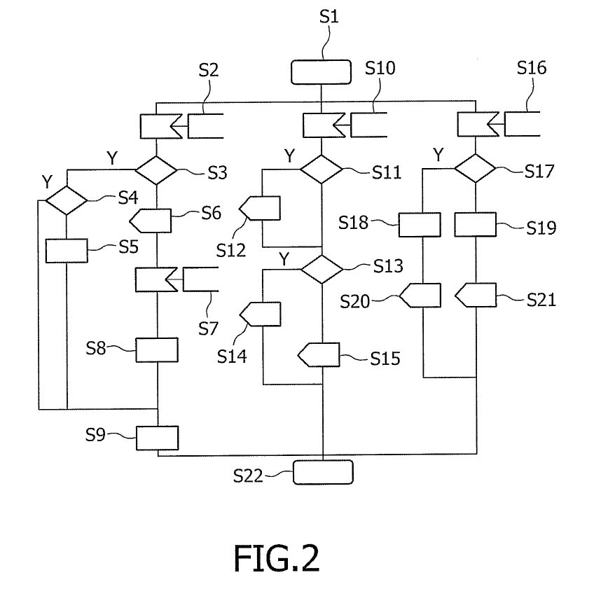

FIG. 2 shows an SDL flow-chart of an exemplary embodiment of a method according to the present invention as it may be performed in the data transmission network of FIG. 1.

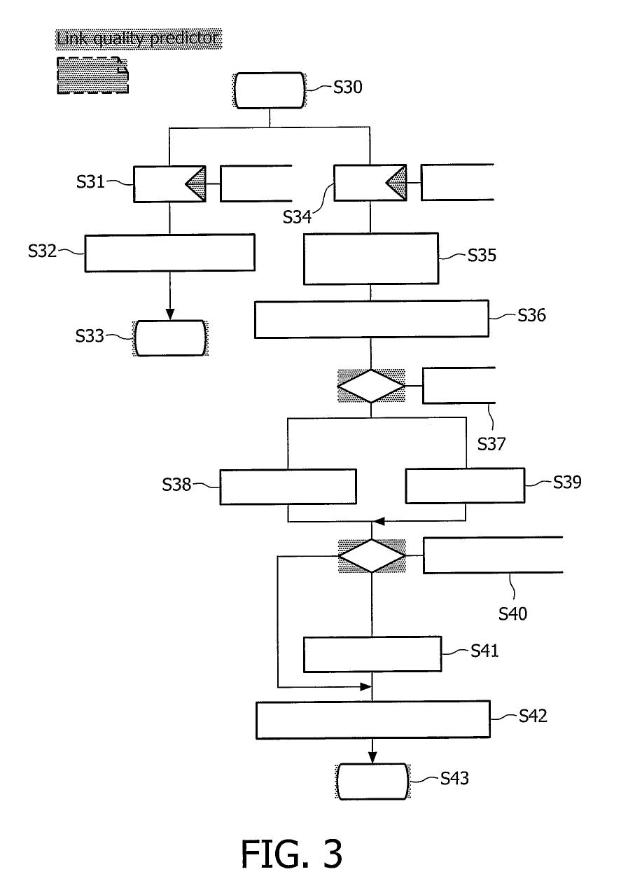

FIG. 3 shows an SDL flow-chart of an exemplary embodiment of a method of determining degrading links according to the present invention.

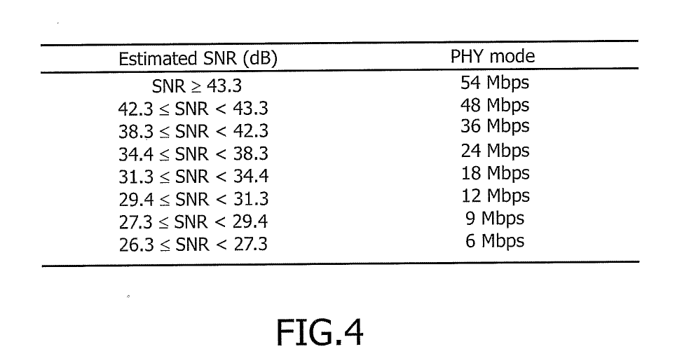

FIG. 4 shows a mapping table of an exemplary embodiment of the present invention to identify the adapted transmission rate to an estimated SNR value.

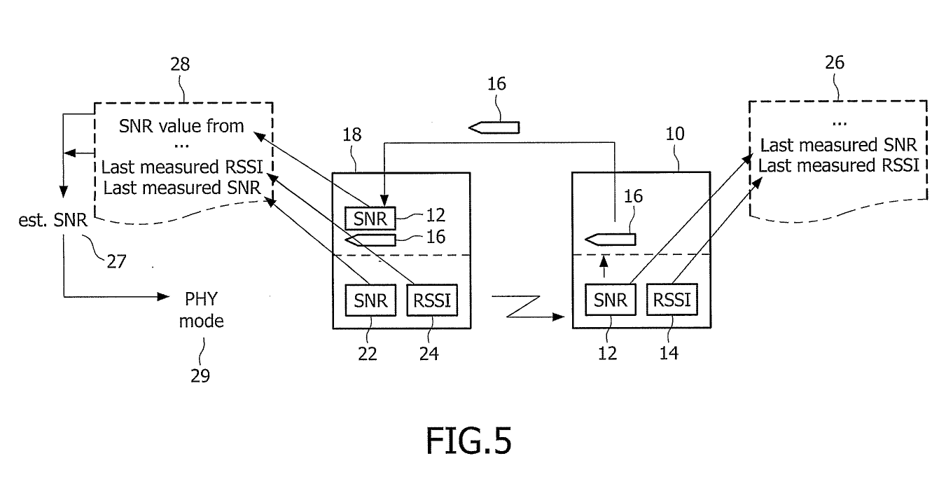

FIG. 5 shows a schematic visualization for further explaining the cross-layer inter-working according to an exemplary embodiment of the present invention.

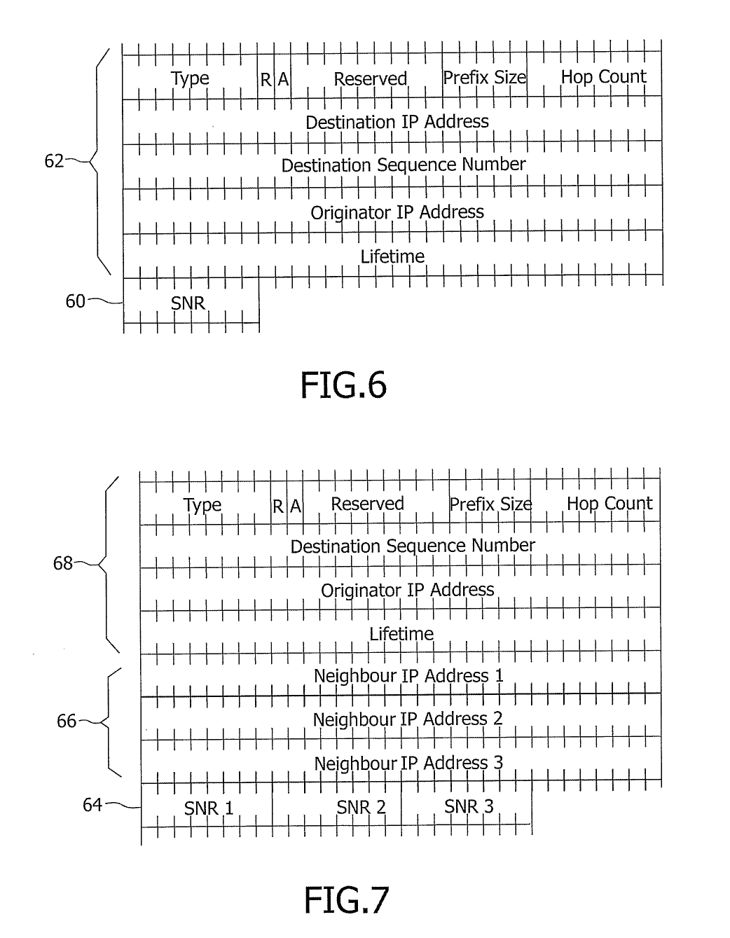

FIG. 6 shows a data packet format for a RREP message according to an exemplary embodiment of the present invention.

FIG. 7 shows a data packet format for a HELLO message according to an exemplary embodiment of the present invention.

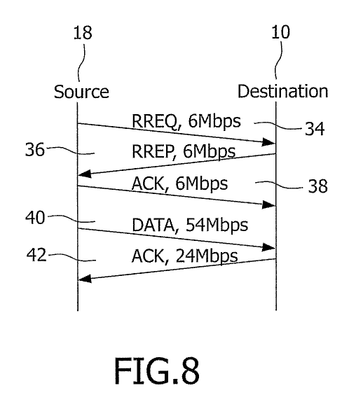

FIG. 8 shows a schematic message flow diagram to further explain the rate control algorithm according to an exemplary embodiment of the present invention.

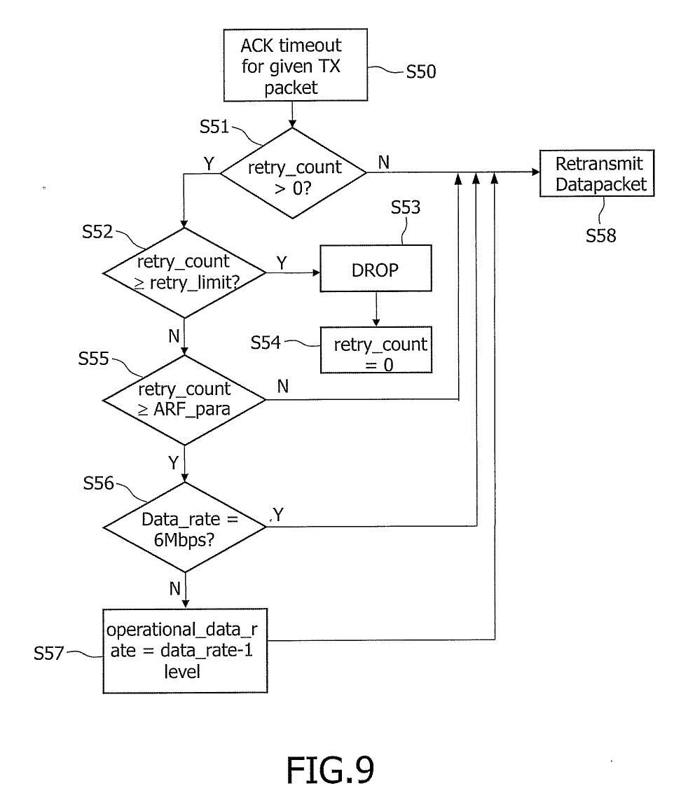

FIG. 9 shows a flow-chart to further explain the autorate fall back mechanism according to an exemplary embodiment of the present invention.

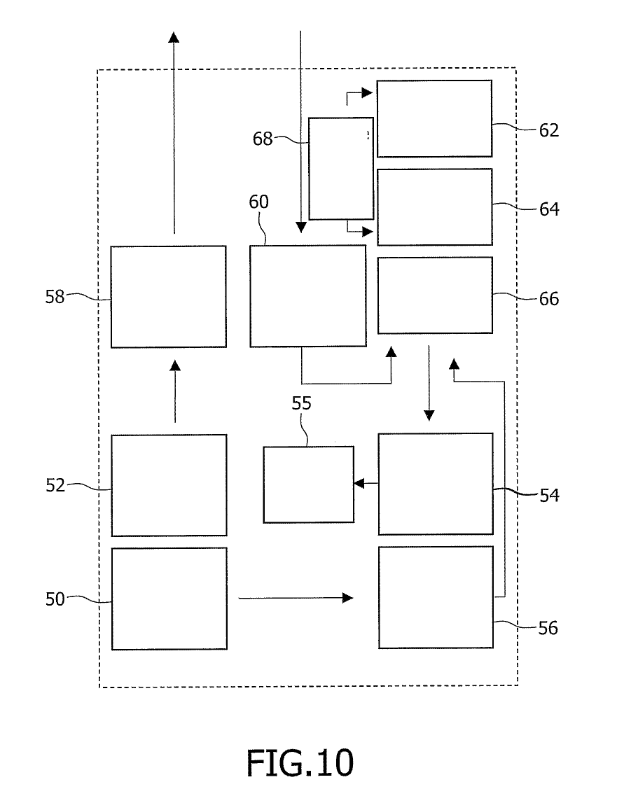

FIG. 10 shows a schematic block diagram of a network node showing the logical link between the functional units of the network node according to an exemplary embodiment of the present invention.

FIG. 1 shows a schematic representation of an exemplary communication network 2 comprising network nodes 4, 6, 8 according to the present invention. The figure shows three types of network nodes. The type of a network node is determined by its role in the network. A source network node 4 (indicated by the letter S), for example, is a network node, which has to send information in the form of a data package to a destination network node 5. A destination network node 8 is a second type of a network node (indicated by the letter D). It is the receiver for a message. A third type of a network node, which is pictured in FIG. 1 is an intermediate network node 6 and in FIG. 1 it is indicated with the letter I. It is responsible for relaying any message, which is sent from the source network node 4 to the destination network node 8. The communication network 2 of FIG. 1 represents a wireless network. The structure of the network is built on an ad hoc basis. That means that network nodes 4, 6, 8 do not rely on any pre-existing network infrastructure. Instead, the network is formed in an on demand fashion as soon as devices are in range of each other. Links 7 connecting neighbouring nodes 4, 6, 8 may be radio links. Their quality depends on environmental parameters like interference, reflections or attenuation caused by the distance between the communication partners.

Nevertheless, in such a mobile ad hoc network 2, many possibilities exist for transmitting data from a source node 4 to a destination network node 8. Finding routes from a source node 4 via intermediate nodes 6 to a destination node 8 is done by routing protocols. An example for a routing protocol for mobile ad hoc network is AODV (Ad hoc On Demand Distance Vector) protocol, which only establishes routes to destinations on an as needed basis. It relies on dynamically establishing route table entries at intermediate nodes 6, which means that each node along a particular path maintains a routing table for each destination node 8 down the same path.

Since a network node 4, 6, 8 in an ad hoc network 2 can act as either a source node 4, an intermediate node 6 or a destination node 8 it should be able to react to different messages it receives.

FIG. 2 shows an SDL flow-chart depicting how network nodes react to the reception of different messages. The SDL flow-chart also shows an exemplary embodiment of a method for using secondary routes according to the present invention. A program described by the SDL flow-chart of FIG. 2 runs on each network node using the suggested method of the present invention. It starts with step S1 and dependent on the received data messages from a neighbouring network node, with which it is connected via a plurality of radio links 7 on an ad hoc basis, the further processing is branched off. If the network node 4 acts as a source node and has data available, which has to be transmitted to a destination network node, the sending process is triggered beginning with step S2. The node now has to find a route to the destination and therefore it makes a look up in its primary and secondary routing table and checks if a route to the destination is available. This step is shown in step S3 of the method. If a valid route to the destination is found in one of the primary and secondary routing table, no route needs to be searched. If the valid route is found in the primary table, in step S4, this route may immediately be used for data transmission. If the valid route is found in the secondary table, the route to the destination is taken from the secondary routing table and the respective route in the primary table is updated with the route gathered from the secondary routing table as indicated in step S5. Then the route from the secondary routing table is deleted, as there is now a valid route in the primary routing table. Using the valid route to the destination, in step S9, the data can be transmitted from the source network node 4 to the destination network node 8. If no valid route to the destination network node 8 has been found, a search for a route has to be started. This is done by sending RREQ (route request) messages in step S6. After sending a RREQ message the node has to wait for a RREP (route reply) message. The RREP message is sent by any other of the intermediate 6 or destination nodes 8, which has a valid route to the destination. Step S8 indicates that on the reception of a valid route, the primary routing table as well as the secondary routing table are updated with the information concerning that new route. Then, with this valid route to the destination, the data can be transmitted to the destination as indicated in step S9.

If the network node 6 receives a RREQ (route request) message it determines that it is an intermediate network node 6. After the reception of an RREQ message in step S10 the intermediate network node 6, in the next step S11, has to check its primary routing table. If there is a route to the destination network node 8 in the primary routing table of the intermediate network node 6, the intermediate network node 6 sends in step S12 an RREP message as a unicast message back to the source network node 4, along the path, established by the RREQ message, which was received. Then and in the case of not having found in step S11 the destination network node 8 in the primary table, in step S13, the intermediate network node makes a look up in the secondary routing table. If it finds a valid route to the destination network node 8 in the secondary routing table, in step S14 it sends an RREP message as a unicast along the path, established by the RREQ message, back to the source network node 4, which was the originator of the RREQ message. If in step S13 no route is found, the node forwards in step S15 an RREQ message to all its neighbouring network nodes. It then returns in step S22 to an idle mode. On the reception of a RREP (route reply) message, as indicated in step S16, the network node identifies in step S17 if it is part of the communication path, described in the RREP message. If the RREP message belongs to a communication path, which the network node is part of, it updates its primary and secondary routing table with the information to the destination included in the received RREP message. This event is performed in step S18. In step 20 it sends the RREP message as a unicast along the path established by the relevant RREQ message back to source network node 4. In the subsequent step 22, the idle mode is reached. If the result of the decision in step S17 is that a network node is not part of the communication path and the RREP message is directed to another station, the node updates its secondary routing table in step S19. In step S21, it sends the RREP message along the path, established by the relevant RREQ message, back to the network node, having requested the relevant RREP message. Then, the network node returns into the idle mode in step S22.

The advantage of deploying a secondary routing table in addition to a primary routing table may be a reduction of overhead by finding new routes. The primary routing tables only maintain routes to a destination node 8 if the network node is part of an active communication path. If there is a request for a new route, the network node 6 has to start a search for the route to the desired destination 8 by flooding the network with RREQ messages. As the secondary routing table also maintains routing information to destinations it is not part of an active communication path, it may have more information of possible destinations in the network 2. Thus the flooding of a whole network with RREQ messages may be limited.

Another advantageous aspect of deploying a secondary routing table may be that it increases the probability of finding alternative stable routes. Each route that is stored in the primary routing table comprises information about:

destination

next hop

number of hops

sequence number for the destination

active neighbours for the route

expiration time for the route table entry.

status of the next hop link stability.

The secondary routing table comprises:

destination

next hop

number of hops

sequence number for the destination

active neighbours for the route

expiration time for the route table entry

status of the next hop link stability.

In addition to the information regarding next hop, number of hops, etc., the stability of the link 7 to the next hop is saved in both routing tables. Since, the stability refers to the link 7, this information could be alternatively stored in the Link quality table 26, 28 that is illustrated in FIG. 5.

To avoid that degrading links may replace existing stable routes a filtering of routing control messages may be performed. As an example, received HELLO or RREP messages belonging to degrading links 7 that would replace an already existing route with a next-hop stable link may be discarded. During a search of stable routes all HELLO or RREP messages belonging to degrading links 7 may also be discarded.

As shown in the following example, taking into account the stability of a link as done in the second routing table, may be advantageous. AODV uses broadcast messages such as HELLO and RREQ messages to find communication paths in the network 2. In IEEE 802.11a systems, broadcast messages are sent at the basic rate, which is 6 Mbps, and as a consequence have a higher range than at the operational speed of the device that could be 54 Mbps. This means that the protocol will find routes, which are able to transmit data at 6 Mbps, but not necessarily at a higher rate. Sending packages on such links 7 with a higher rate results in a high packet loss as the rate is not adapted to the quality of the link 7. Degrading links 7 usually have bad Quality of Service (QoS) parameters. One possible reason for a bad QoS might be a large distance between network nodes 4, 6, 8. Transmitting messages with a low data rate, for example 6 Mbps, could be possible whereas the transmission with a higher data rate, for example 54 Mbps, may result in a loss of packages. If a routing protocol optimizes its routes according to the minimum number of hop counts without the rate and the reliability of a link 7, a stable link could be replaced with a degrading one, with a smaller number of hops to the destination 8.

FIG. 3 shows an SDL flow-chart of an exemplary embodiment of a method of determining degrading links according to the present invention. The method shown in FIG. 3 is implemented on each network node 4, 6, 8. The method starts with step S30. Each time a packet is received, as shown in S31, the received signal strength (RSSI) of the received packets is measured. The RSSI value is measured by the physical layer of a network node 4,6,8 each time a packet is received and it is an indication for the QoS for the link. The present invention proposes the use of a predictor of a link quality based on variation of the received signal strength (ΔRSSI). During a preset time window for each packet received from a neighbour, its RSSI level (RSSI) is measured and the accumulative average (RSSIₐᵥ) is updated. According to the following formula, the actual measured RSSI (n) value from the received packet is taken and weighted with the factor (1−α). α is a constant design factor in the range between 0 to 1 that determines the speed of detection of link changes (e.g. α=0.6). It controls the relative weight of recent and past history in the prediction. The smaller α is, the more that the most recent period is taken into account in the next prediction.

RSSIₐᵥ(n+1)=αRSSIₐᵥ(n)+(1−α)RSSI(n)

RSSIₐᵥ(n+1) is the new predicted value for the accumulative average RSSIₐᵥ. RSSIₐᵥ (n) is the last predicted value and RSSI(n) is the last measured RSSI value. In other words, at the time (n) the value of RSSI(n) is measured and in combination with the last predicted RSSIₐᵥ(n) value a new value for RSSIₐᵥ(n+1) is predicted.

This value is calculated by the method in step S32 each time a packet is received. In step S33, the idle mode is reached.

When a timer indicates an end of the preset time window in step S34, the RSSI variation is predicted. Therefore the difference ΔRSSI between the RSSI average values in the last two time windows (n) and (n−1) is calculated in step S35. ΔRSSI, the predicted variation of the received signal strength, is calculated according to the following formula.

ΔRSSI=RSSIₐᵥ(n)−RSSIₐᵥ(n−1)

RSSIₐᵥ(n) is the predicted accumulative average RSSI value at time (n) and RSSIₐᵥ(n−1) is the predicted accumulative average RSSI value at time (n−1). Wherein (n) and (n−1) indicate two different succeeding points in time.

The old link state is read in the next step S36 from the secondary routing table. The predicted RSSI variation (ΔRSSI) value is a value according to the QoS of a link 7. In step S37 the RSSI variation is compared to a threshold, which depends on the present rate of the link 7. If ΔRSSI is less than this threshold, the link state in step S38 of the method is classified as degrading. Otherwise in step S39 the link state is declared as stable. The old link state, read in step S36 from the secondary routing table, is compared in step S40 with the actual link state determined in step S38 or S39. If this test realizes that the state of the link changes from stable to degrading, a method for finding stable routes is started in step S41. The actual state of the link is written back to the relevant route in the secondary routing table in step S42. Then with step S43 the node returns into the idle mode waiting for new events. During the search for a stable route, the degrading route will still be used until a stable route is found. This may be a smooth transition between routes without degrading the QoS. Only if no stable route can be found, routes that might be composed by degrading links are created. An advantage of the method suggested in FIG. 3 may be considering the data rate in combination with the variation of the signal strength to classify the state of the link. In other words, a route has, from a stability point of view, a relationship between the QoS parameter variation of the signal strength and the data rate. So it is advantageous taking into account these both parameters for the qualification of the status of a route. Also, a gradient e.g. of the reception errors may be used for determining the link quality. A positive gradient indicates an improving condition, a negative gradient indicates a degrading condition.

FIG. 4 shows a mapping table of an exemplary embodiment of the present invention to identify the adapted transmission rate to an estimated SNR (signal to noise ratio) value. This mapping is used for rate control of the physical transmission rate of a link. On the left side of the table thresholds for an estimated SNR level in dB (Dezibel) are provided. The SNR value relates to the signal strength of a link 7. Each level has a corresponding PHY mode it is mapped to. The PHY mode is a physical data rate used by the network node to send data packets to an other network node. As described above, the classification of a link 7 as degrading or stable depends on the transmission rate to be in due proportion to the signal strength of a link 7. If the rate is not adequate to the signal strength of the channel, the link 7 might be designated as degrading. Advantageously, according to an exemplary embodiment of the present invention, a rate control algorithm is suggested. A rate control algorithm takes advantage of effectively change the data rate of a multi-rate system like IEEE 802.11a in ad hoc configuration. The rate control mechanism works together with the routing protocol on a higher layer to take into account the quality of each link 7, which is detected on a lower protocol layer. This cross layer solution is based on the change in RSSI, in conjunction with the SNR measured at the receiving node of a data package and feedback to the sending network node of the data package through routing control messages as shown in FIG. 5. This SNR value is used to quickly and accurately estimate the initial link 7 condition and selecting the PHY (physical) rate for the first transmission. Changes in the link condition due to the mobility of nodes for example, are determined by calculating the change in RSSI, which has a linear relationship with the average SNR. Using this change in RSSI, the SNR value at the receiving network node can therefore be estimated as shown below.

SNRₑₛₜᵢₘ(n)=SNRₑₛₜᵢₘ(n−1)+ΔRSSI

ΔRSSI is the predicted RSSI variation calculated in one of the steps S32 and S35.

Based on the mapping shown in the table of FIG. 4 by comparing the calculated SNRₑₛₜᵢₘ value with the fixed thresholds on the left side of the table of FIG. 4, the respective PHY mode can be chosen for the next data transmission on the respective link 7. Since the channel conditions can change with time, the relation between SNR and the optimum rate can be variable. Therefore, instead of selecting the rate based on fixed thresholds as indicated in FIG. 4, the present invention may use an adaptive estimator that adapts the threshold values to the channel dynamics. As mentioned above the SNR value 12 is measured at the receiving network node 10 but it is the transmitting network node 18, which selects the rate for the transmission. This SNR value 12 is sent to the transmitting network node 18 via control packets 16 of the routing protocol in a higher layer.

FIG. 5 shows a schematic visualization for further explaining the cross-layer inter-working according to an exemplary embodiment of the present invention. In FIG. 5 a first network node 18 and second network node 10 are shown. The first network node 18 needs to transmit information to the second network node 10. Therefore it needs to identify at which transmission rate this transmission is possible. Every time when network node 18 sends information to the second network node 10, the second network node 10 measures an SNR value 12 and the RSSI value 14. Both values it stores in its link quality table 26, 28 according to the following format:

Neighbour IP Address
The IP address of the next hop neighbor
SNR value from packet
The SNR value from the RREP or HELLO packet generated by the next
hop neighbour
Last measured SNR value
The measured SNR value at the receiver of packets generated by the next
hop neighbour
Last measured RSSI value
The measured RSSI value at the receiver of packets generated by the next
hop neighbor
RSSI change (ΔRSSI)
The change in RSSI value between two consecutive packets received from
the same next hop neighbor. Default value is 0.
Estimated SNR value (SNRₑₛₜᵢₘ)
SNR value from packet + RSSI change
Rate
The current rate of the link, as determined by estimated SNR value. If
there is no estimated value, a default value of 6 Mbps is used in 802.11a

As the SNR value 12 is needed at the transmitter 18 the second network node 10 encapsulates this PHY layer measurement into a higher layer message (e.g. RREP) 16 and sends it to the transmitter 18. By doing this, the standard protocol for transferring data from one node to another may be used. At the transmitter 18 the value is decapsulated and put into the link quality table 28 of the first network node 18. The first network node also measures the SNR value 22 and RSSI value 24 of the second network node 10. With these values the first network node 18 can calculate the estimated SNR value 27 that is needed to determine the adequate transmission rate 29 of the link.

Messages that could transport the SNR value 12 from one node to another could be the RREP and HELLO packets that might be adapted. The required adaptation of these both message formats are shown in FIG. 6 and FIG. 7.

FIG. 6 shows a data packet format for an RREP message according to an exemplary embodiment of the present invention. A data packet usually is provided as groups of Bits. For a better graphical visualisation bits are grouped in columns and rows. In FIG. 4 a row consist of 32 bits equalling 4 Bytes. A Byte is a group of 8 Bits. The first 5 rows in FIG. 4 are identical to a standard RREP message 62 used in the AODV protocol. The meaning of the Bits is shown in the following table:

| Bits | Meaning |
|---|---|
| 1-8 | Type |
| 9 | R Flag |
| 10 | A Flag |
| 11-19 | Reserved |
| 20-24 | Prefix Size |
| 25-32 | Hop Count |
| 33-64 | Destination IP Address |
| 65-96 | Destination Sequence Number |
| 97-128 | Originator IP Address |
| 129-160 | Lifetime |

In addition to the standard RREP message format used in the AODV protocol 62, a field 60 (Bits 161-168) for the transport of an SNR value is used in this exemplary embodiment of the present invention.

FIG. 7 shows a data packet format for a HELLO message according to an exemplary embodiment of the present invention. The first 4 rows in FIG. 4 are identical to a standard HELLO message 68 used in the AODV protocol. The meaning of the Bits is shown in the following table:

| Bits | Meaning |
|---|---|
| 1-8 | Type |
| 9 | R Flag |
| 10 | A Flag |
| 11-19 | Reserved |
| 20-24 | Prefix Size |
| 25-32 | Hop Count |
| 33-64 | Destination Sequence Number |
| 65-96 | Originator IP Address |
| 97-128 | Lifetime |

In contrast to a HELLO message format used in the AODV protocol 68, fields 66 for three neighbour addresses (Bits 129-160, Bits 161-192, Bits 193-224) and the respective SNR values 64 (Bits 225-232, Bits 233-240, Bits 241-248) are added. That may be done, since these packets are broadcast packets and have to transport information for three neighbours. Three neighbours may be the maximum number of neighbours a network node monitors.

FIG. 8 shows a schematic message flow diagram to further explain the rate control algorithm according to an exemplary embodiment of the present invention. It shows the behaviour of the rate control algorithm with an example of a higher layer (e.g. layer 3) protocol (AODV) and a lower layer (e.g. layer 2) protocol (IEEE 802.11a). A source node 18 wants to determine the adequate transmission rate to a destination 10. First, an RREQ packet 34 is broadcasted over the network at the mandatory rate of 6 Mbps as per IEEE 802.11. When the destination node 10 receives this RREQ message it measures the SNR value 12 and the RSSI value 14 of this packet 34 and updates these values in the “last measured SNR value” and “last measures RSSI value” field of the table 26 for this neighbour. As there is no value for the “estimated SNR value”, the RREP message 36 is sent back at a default value of 6 Mbps with the last measured SNR value included in the packet 36, 16. The source 18 decapsulates this packet 36, 16, reads the SNR value 12 which it then puts in the “SNR value from packet field” of the table 28 for this neighbour 10. The source 18 also measures the SNR 22 and RSSI 24 value of the RREP 36, 16 for its neighbour 10 and puts these values in the last measured SNR value and last measured RSSI value for this neighbour 10. The estimated SNR value 27 is then calculated and the respective PHY mode 29 is then calculated.

In FIG. 8 the so-called ACK (acknowledge) packet 38, confirms the correct reception of a unicast packet, in this example the reception of the RREP message 36. Independent of the calculated PHY mode, ACK packets 38 are always sent at the 802.11-manadatory data rate closest to the last received packet. In this case the last received packet was RREP packet 36 at 6 Mbps and thus the ACK packet 38 is transmitted at 6 Mbps as well. The subsequent data packet 40 that follows, is transmitted using this chosen PHY mode, which in this case may be 54 Mbps. The ACK package 42 from the destination 10 is again determined from the PHY mode used for the data packet transmission 40. So it might be sent at a rate of 54 Mbps, but as the upper limit for the transmission rate of an ACK package 42 is 24 Mbps, the rate is less than the rate of the received data package.

When no ACK packets 42 are received and data packets 40 need to be re-transmitted, the present invention uses an autorate fall back mechanism to reduce the rate.

FIG. 9 shows a flow-chart to further explain the autorate fall back mechanism according to an exemplary embodiment of the present invention. This mechanism is used to reduce the PHY mode after particular number of missed ACKs, an indicator for a bad link quality. On the other side it increases the PHY mode after a following successive number of received ACKs, testing the quality of a link by sending probes at the increased bandwidth. The method starts with step S50, when a timer signals, that for a longer period of time no ACK packet has been received, indicating, that the quality of the relevant link 7 may be too bad for the actual transmission rate. In the next step S51 a decision is made if a certain number of retries has been exceeded. If the number is not exceeded, in step S52 the number of retries is checked if it exceeds a certain retry limit. If the number is higher than the retry limit, the packet is dropped in the next step S53 and the number of retries in step S54 is set to 0. If the retry counter does not exceed a certain retry limit, in step S55 the retry counter is checked if it exceeds an autorate fall back parameter. If the retry counter does not exceed the autorate fall back parameter, the data packet is re-transmitted in step S58. In the case that the retry counter exceeds the autorate fall back parameter in step S56, the data rate is checked if it has reached the lowest level of 6 Mbps. If this lowest level is reached, the network node continually re-transmits in step S58 the data packet with that data rate. If this lowest level is not yet reached, the data rate is reduced by one level in step S57 and then the data packet is re-transmitted in S58 at this reduced data rate.

FIG. 10 shows a schematic block diagram of a network node showing the logical link between the functional units of a network node according to an exemplary embodiment of the present invention. Each network node includes a memory 62 for a primary and a memory 64 for a secondary routing table. They store discovered routes to a destination network node until they are deleted after the expiration of an expiration timer. A stable route finder 68 seeks for stable routes to a destination. It also monitors their status and triggers the search of new routes in the case of degrading stability. For the identification of the state of a route, it uses the RSSI variation calculator 56. As an input the RSSI variation calculator 56 receives measurement values gathered by an RSSI-meter 50. The RSSI-meter 50 measures the signal strength of the relevant link. The stable route finder 68 compares the RSSI variation values to a threshold dependent on the transmission rate and uses the result of the comparison as a basis for the decision if a search for a new route has to be triggered. The RSSI variation calculator 56 stores its values in a memory for the link quality table 54. The SNR values, received from a neighbour network node, are also stored in that memory. They are sent from the neighbour network node encapsulated in a control message 16 and decapsulated by the cross-layer decapsulation function 60. With these both values the SNR estimator 54 calculates an estimated SNR. That value the PHY mode selector 55 uses to find the adequate PHY mode. The PHY mode selector 55 controls the physical transmission rate.

The SNR meter 52 measures, for each packet received by the network node, the actual SNR value and sends it back to the transmitting neighbour network node. Therefore it encapsulates the value with the cross-layer encapsulation function 58. It converts lower level values into higher level messages that can by sent as standard messages used by the relevant protocol.

The functional blocks SNR estimator 54, RSSI variation calculator 56, PHY mode selector 55, stable route finder 68, cross-layer encapsulation function 58 and cross-layer decapsulation function may be implemented on a microprocessor. The SNR-meter 52 and RSSI-meter 50 may be sensors connected to the microprocessor and providing the relevant values at their interfaces. The memory for primary routing table 62, memory for secondary routing table and memory for link quality table may be realized with standard memory units e.g. SDRAM.

It should be noted that the term “comprising” does not exclude other elements or steps and the “a” or “an” does not exclude a plurality and that a single processor or system may fulfil the functions of several means recited in the claims. Also elements described in association with different embodiments may be combined.

It should also be noted that any reference signs in the claims shall not be construed as limiting the scope of the claims.

1. A method for transmitting data in a communication network, comprising the steps of:
transmitting data via a first data transmission route;
determining a quality variation of the first data transmission route; and
amending the first data transmission route on the basis of the quality variation.

2. The method of claim 1, further comprising the step of:
switching the first data transmission route to a second data transmission route.

3. The method of claim 1, further comprising the step of:
determining a degrading condition of the first data transmission route.

4. The method of claim 1, further comprising the step of:
determining the quality variation of the first data transmission route on the basis of a received signal strength.

5. The method of claim 1, further comprising the steps of:
storing information concerning a third data transmission route in a primary routing table (62);
storing information concerning a fourth data transmission route in a secondary routing table (64);
wherein, if a degrading condition of the third data transmission route is determined, a data transmission is initiated via the fourth data transmission route.

6. The method of claim 1, further comprising the steps of:
determining a message received via a fifth data transmission route, which has a degrading condition; and
discarding the message.

7. The method of claim 1, further comprising the step of:
amending the first data transmission route by adjusting a data transmission rate of the first data transmission route.

8. The method of claim 7, further comprising the steps of:
determining a degrading condition of the first data transmission route; and
reducing the data transmission rate in case the degrading condition is determined.

9. The method of claim 7, further comprising the steps of:
determining an improving condition of the first data transmission route; and
increasing the data transmission rate in case the improving condition is determined.

10. A network node for a data transmission network,
wherein the network node (4, 6, 8) is adapted to transmit data via a link (7) via a first data transmission route;
wherein the network node (4, 6, 8) is adapted to determine a link quality variation of the first data transmission route;
wherein the network node (4, 6, 8) is adapted to amend the first data transmission route on the basis of the link quality variation.

11. The network node of claim 10,
wherein the network node (4, 6, 8) is adapted to switch the data transmission from the first data transmission route to a second data transmission route.

12. The network node of claim 10,
wherein the network node is adapted to detect a degrading condition of the first data transmission route.

13. The network node of claim 10,
wherein the network node (4, 6, 8) is adapted to determine the link quality variation of the first data transmission route on the basis of a received signal strength.

14. The network node of claim 10,
wherein the network node (4, 6, 8) is adapted to amend the first data transmission route by adjusting a data transmission rate on the first data transmission route.

15. The network node of claim 14,
wherein the network node is adapted to reduce the data transmission rate of a link (7) in case of a degrading link quality.

16. The network node of claim 14,
wherein the network node (4, 6, 8) is adapted to increase the data transmission rate of a link (7) in the case of an improving link quality.

17. A communication network,
wherein the communication network is a wireless communication network, the communication network comprising:
a first network node (18) and a second network node (10);
wherein the first network (18) node is adapted to transmit data via a first data transmission route to the second network node (10);
wherein the first network node (18) is adapted to determine a quality variation of the data transmission via the first data transmission route; and
wherein the first network node (18) is adapted to amend the first data transmission route on the basis of the quality variation.

18. The network of claim 17,
wherein the first network node is adapted to change the data transmission from the transmission via the first data transmission route to the transmission via a second data transmission route on the basis of quality variation.

19. The network of claim 17,
wherein the first network node (18) is adapted to alter a data transmission rate over the first data transmission route on the basis of the quality variation.
